(19) United States
(12) Patent Application Publication
(10) Pub. No.: US 2015/0016997 A1
(43) Pub. Date: Jan. 15, 2015

(54) WIND TURBINE ROTOR HAVING VERTICAL BLADES

(71) Applicant: YOUNG-SIL YU, SEOUL (KR)

(72) Inventor: YOUNG-SIL YU, SEOUL (KR)

(21) Appl. No.: 14/156,422

(22) Filed: Jan. 15, 2014

(30) Foreign Application Priority Data
Jul. 15, 2013 (KR) 10-2013-0082556

(51) Int. Cl. F03D 3/06

(52) U.S. Cl. CPC F03D 3/068
USPC 416/147

(57) ABSTRACT

Provided is a wind turbine rotor having vertical blades, which includes: fixing bars that are radially separated from and fixed to the end discs at a given angle and pivotably attach the vertical blades to ends thereof via hinge pins; an eccentric coupling that is pivotably attached to the upper end of the rotary shaft attached to the end discs via a first bearing and has an eccentric stud protruding from an upper surface thereof; an annular eccentric disc that is pivotably attached to an outer circumferential surface of the eccentric stud via a second bearing; a wind direction bar that is integrally fixed to an upper portion of the eccentric stud; and linkages that are connected so that a distance between the eccentric disc and each vertical blade is adjusted and function to change a wind direction angle of each vertical blade around each hinge pin.

### CROSS-REFERENCE TO RELATED APPLICATION

This application claims the priority benefit of Korean patent application serial no. 10-2013-0082556, filed on Jul. 15, 2013. The entirety of the above-mentioned patent application is hereby incorporated by reference herein and made a part of this specification.

### BACKGROUND OF THE INVENTION

1. Field of the Invention

The present invention relates to a wind turbine rotor having vertical blades whose angles vary depending on a direction of wind.

2. Description of the Related Art

Wind power generation technologies have been developed in various types such as a propeller type, a cylindrical blade type, and so on. However, due to the variable intensity of wind power, it is difficult to generate constant electricity.

A structure in which angles of vertical blades are variably increased on an outer surface of a rotor of a wind turbine is disclosed in Korean Patent Nos. 10-0620948, 10-0743475, and 10-0938669 (first technical group).

A structure in which wind power is generated while angles of vertical blades are variably reduced inward on a surface of a rotor of a wind turbine having a true circle is disclosed in Korean Unexamined Patent Application Publication No. 10-2010-0084805 and Korean Patent No. 10-1121012 (second technical group). The vertical blades are designed to be spread or closed in the vicinity of corners thereof.

In these structures, each vertical blade forms a true circle having the same axis as a cylinder at normal times, and is spread only when wind exceeds a predetermined pressure (first technical group), or is closed (second technical group). The structures have a static period (time required to meet a wind pressure condition that the blades are spread or closed) from a static state to the moment the blades begin first rotation. As such, no wind turbine that can generate electricity by rotation of the rotor in the direction of wind under very low wind pressure has been developed.

Further, technology in which the rotor of the wind turbine is eccentrically rotated around a rotary shaft so as to spread or close the blades in the direction of wind is disclosed in Korean Patent No. 10-0938669. However, since the rotary shaft has an eccentric shaft installed only on an upper end thereof, vibration occurs, and a structure thereof is complicated.

In addition, when the blades of the rotor of the wind turbine are subjected to the wind pressure, the blades move into the rotor to form spaces, and the rotor is rotated by the wind pressure applied to the spaces. The rotor is separated from a rotating force by an eccentric bearing installed between the rotor and a rotary shaft, and a wind guide is attached to an upper end of the eccentric bearing. The vertical blades are spread by the wind pressure generated by a rotating force of the eccentric bearing cooperating with an operation of the wind guide. This technology is disclosed in Korean Unexamined Patent Application Publication No. 10-2010-0084805. However, as the blades move into the rotor, it is difficult for the rotor to be rotated when the wind pressure is low. Further, since the eccentric bearing is exposed, durability is reduced.

### SUMMARY OF THE INVENTION

Accordingly, the present invention has been made in an effort to solve the problems occurring in the related art, and an object of the present invention is to provide a wind turbine rotor having vertical blades whose angles vary depending on a direction of wind, in which the vertical blades are radially installed, are inclined at given angles depending on the wind direction by fixing bars that receive rotating forces of the vertical blades and function as hinges for adjusting a rotational angle and by an eccentric disc that is rotated by an eccentric stud pivotably attached so as to perform an eccentric function on a rotary shaft, and are automatically spread to function to generate electricity at a windward side depending on the wind direction by an organic action of linkages adjusting the inclined angles of the vertical blades.

Another object of the present invention is to provide a wind turbine rotor having vertical blades whose angles vary depending on a direction of wind, in which an eccentric stud protrudes upward from an eccentric coupling that is pivotably attached to a vertical shaft receiving a rotating force from the vertical blades, and the eccentric coupling is coupled to an eccentric disc for adjusting the angles of the vertical blades and transmits an eccentric force, so that a rotary shaft is rotated forward, and the angle of the vertical blades are adjusted without noise via linkages by the eccentricity of the eccentric coupling depending on the wind direction.

Another object of the present invention is to provide a wind turbine rotor having vertical blades whose angles vary depending on a direction of wind, in which one of link pins by which first links and second links constituting respective linkages transmitting an eccentric force to the vertical blades are pivotably coupled is fixed as a stationary pin and functions as a power transmission pin for link coupling, so that the angles of the vertical blades vary depending on the wind direction without a separate link adjusting means.

In order to achieve the above objects, there is provided a wind turbine rotor having vertical blades whose angles vary depending on a direction of wind, in which the vertical blades supported on end discs attached to opposite ends of a rotary shaft are rotated by wind energy, the wind turbine rotor. The wind turbine rotor includes: fixing bars that are radially separated from and fixed to the end discs at a given angle and pivotably attach the vertical blades to ends thereof via hinge pins; an eccentric coupling that is pivotably attached to the upper end of the rotary shaft attached to the end discs via a first bearing and has an eccentric stud protruding from an upper surface thereof; an annular eccentric disc that is pivotably attached to an outer circumferential surface of the eccentric stud via a second bearing; a wind direction bar that is integrally fixed to an upper portion of the eccentric stud; and linkages that are connected so that a distance between the eccentric disc and each vertical blade is adjusted and function to change a wind direction angle of each vertical blade around each hinge pin.

According to the present invention, the vertical blades are radially installed on the rotor, are inclined at given angles depending on the wind direction by fixing bars that receive rotating forces of the vertical blades and function as hinges for adjusting a rotational angle and by an eccentric disc that is rotated by an eccentric stud pivotably attached so as to perform an eccentric function on a rotary shaft, and are automatically spread to function to generate electricity at a windward side depending on the wind direction by an organic action of linkages adjusting the inclined angles of the vertical blades.

Further, the eccentric stud protrudes upward from the eccentric coupling that is pivotably attached to a vertical shaft receiving a rotating force from the vertical blades, and the eccentric coupling is coupled to an eccentric disc for adjusting the angles of the vertical blades and transmits an eccentric force, so that the rotary shaft is rotated forward, and the angle of the vertical blades are adjusted without noise via the linkages by the eccentricity of the eccentric coupling depending on the wind direction.

In addition, one of the link pins by which the first links and the second links constituting the respective linkages transmitting an eccentric force to the vertical blades are pivotably coupled is fixed as a stationary pin and functions as a power transmission pin for link coupling, thereby removing a need for a separate link adjusting means.

### BRIEF DESCRIPTION OF THE DRAWINGS

The above objects, and other features and advantages of the present invention will become more apparent after a reading of the following detailed description taken in conjunction with the drawings, in which:

FIG. 1 is an exploded perspective view showing a wind turbine rotor according to an embodiment of the present invention;

FIG. 2 is a partial cross-sectional view showing an assembly of the wind turbine rotor according to the embodiment of the present invention;

FIG. 3 is a cross-sectional view showing essential components of a wind turbine rotor according to another embodiment of the present invention;

FIG. 4 is a plan view showing a state in which a wind direction bar is omitted from the wind turbine rotor according to the other embodiment of the present invention;

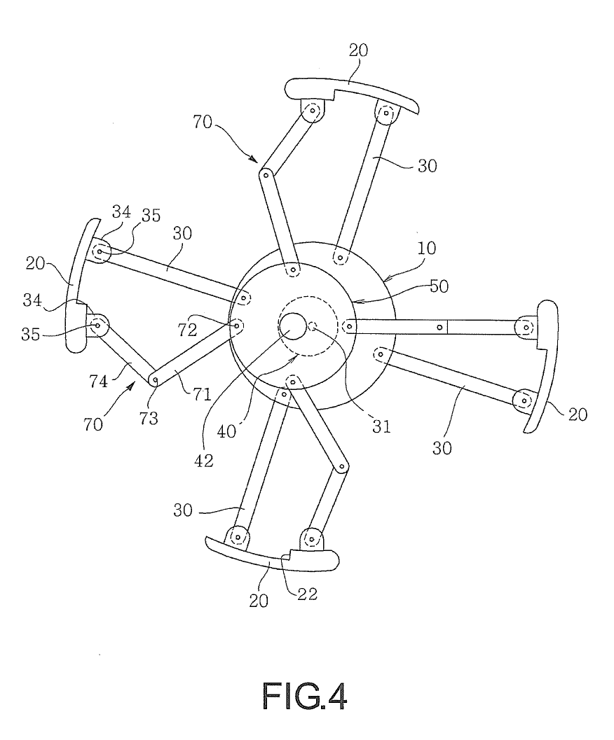

FIG. 5 is a partial plan view showing how angles of vertical blades of the wind turbine rotor according to the other embodiment of the present invention are changed; and

FIG. 6 is a plan view showing how the wind turbine rotor according to the other embodiment of the present invention is operated.

### DETAILED DESCRIPTION OF PREFERRED EMBODIMENTS

Reference will now be made in greater detail to exemplary embodiments of the present invention with reference to the accompanying drawings.

The present invention provides a wind turbine rotor, in which vertical blades supported on end discs attached to opposite ends of a rotary shaft are rotated by wind energy, comprising:
fixing bars 30 that are radially separated from and fixed to the end discs 10 at a given angle and pivotably attach the vertical blades 20 to ends thereof via hinge pins 32 for adjusting a rotational angle;
an eccentric coupling 40 that is pivotably attached to the upper end of the rotary shaft 31 attached to the end discs 10 via a first bearing 41 and has an eccentric stud 43 protruding from an upper surface thereof;
an annular eccentric disc 50 that is pivotably attached to an outer circumferential surface of the eccentric stud 43 via a second bearing 42;
a wind direction bar 60 that is integrally fixed to an upper portion of the eccentric stud 43; and
linkages 70 that are connected so that a distance between the eccentric disc 50 and each vertical blade 20 is adjusted and function to change a wind direction angle of each vertical blade 20 around each hinge pin 32.

Each vertical blade 20 includes the hinge pins 32, each of which is pivotably attached to a hinge bracket 33 on one side of an inner surface thereof, and a link pin 35 attached to a link bracket 34 on the other side of the inner surface thereof at a position spaced apart from the hinge pin 32 in a widthwise direction.

The linkages 70 are pivotably attached to the respective link pins 35.

Each linkage 70 includes a first link 71, one end of which is pivotably attached to the eccentric disc 50 via a link pin 72 in a radial direction, and a second link 74, one end of which is linked to the other end of the first link 71 via a middle link pin 73.

The other end of the second link 74 is pivotably attached to the link pin 35.

One of the middle link pins 73 of the first links 71 disposed in a radial direction is fixed as a fixing screw.

Each vertical blade 20 is provided with a step 22 on an inner or outer surface thereof which increases wind pressure.

The eccentric disc 50 includes a bearing dam 52 that protrudes from a bottom surface thereof in a ring shape so as to hold the second bearing 42, and an eccentric stud hole 54 that is formed around a central axis thereof so as to prevent a rotating force thereof from being transmitted to the eccentric stud 43 and functions to fix a lower end of a wind direction bar fixing shaft 62 coupled with the wind direction bar 60 to the eccentric stud 43 so that the wind direction bar fixing shaft 62 is located.

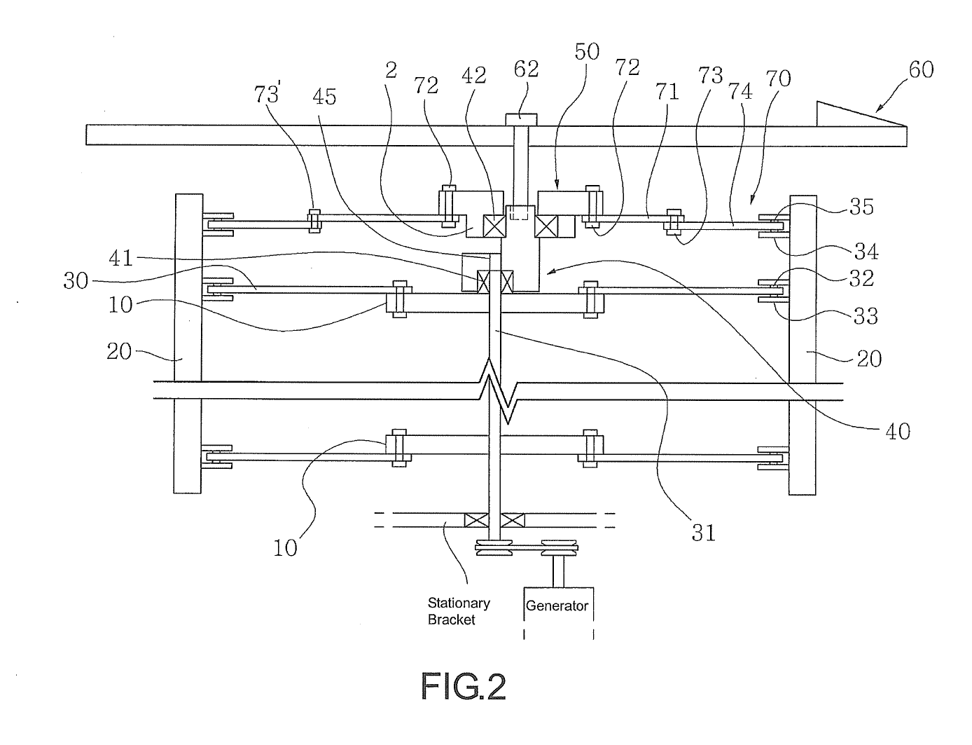

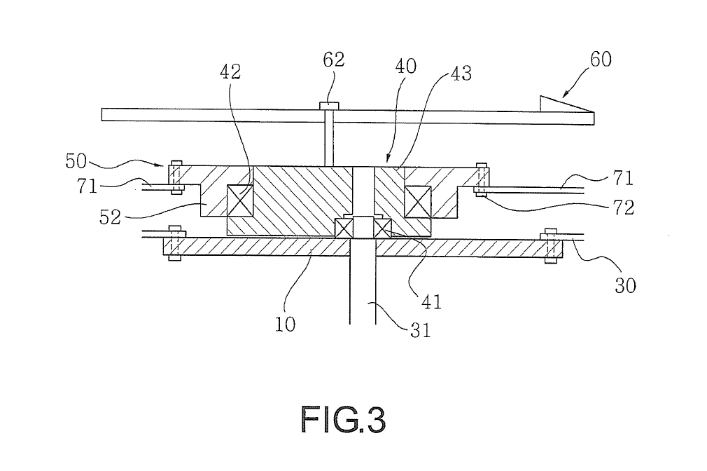

FIG. 3 shows another embodiment of FIG. 2 which modifies a shape of the eccentric stud 43. Since substantial function and configuration of the present embodiment are equal to those of the previous embodiment, detailed description thereof will be omitted.

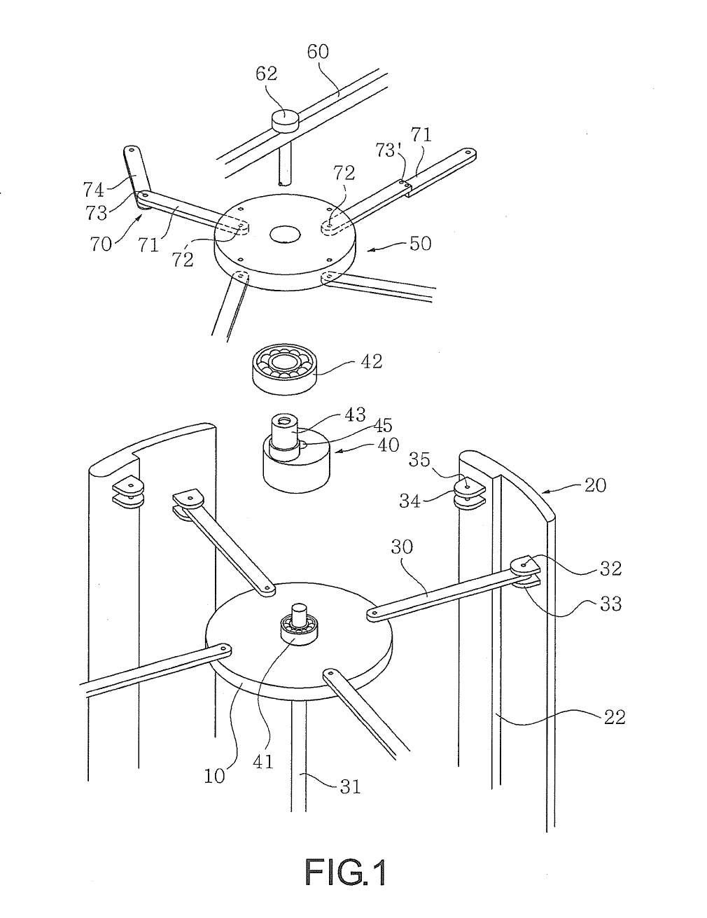

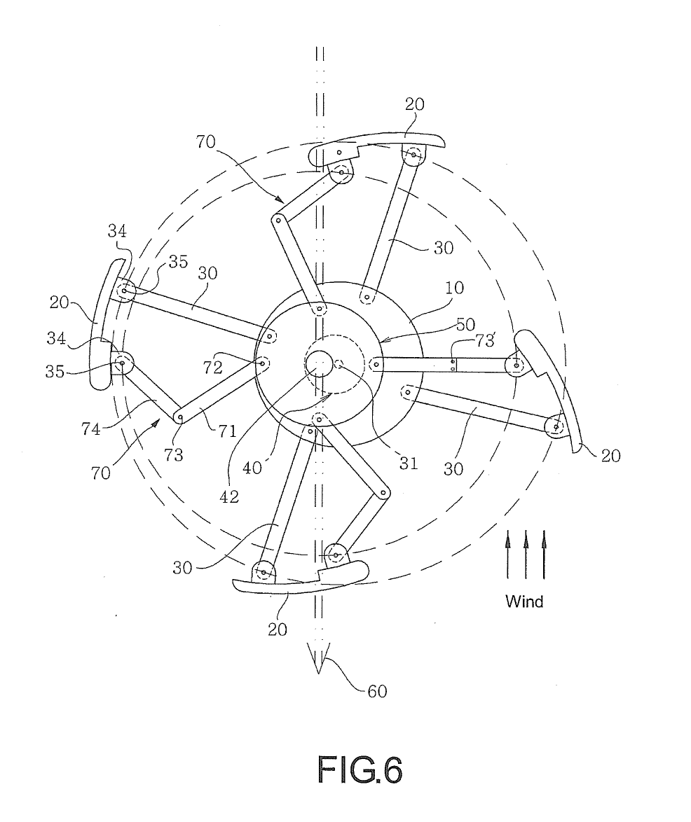

In the wind turbine rotor configured in this way, the vertical blades 20 are pivotably attached to outer ends of the fixing bars 30 radially fixed to the end discs 10 attached to the rotary shaft 31 via the hinge pins 32 pivotably attached to the hinge brackets 33 as shown in FIG. 1, and are rotated around the rotary shaft 31 in a rotary diameter of the fixing bars as shown in FIG. 6.

Further, the eccentric coupling 40 is pivotably attached to the upper end of the rotary shaft 31 via the first bearing 41. The eccentric stud 43 protrudes from the upper surface of the eccentric coupling 40. The second bearing 42 is fitted around the protruding eccentric stud 43. In this state, the eccentric coupling 40 is pivotably fitted into the bearing dam 52 of the eccentric disc 50.

Next, the wind direction bar fixing shaft 62 is fixed to the upper portion of the eccentric stud 43 so that the wind direction bar 60 and the eccentric coupling 40 move together in parallel to a direction of wind.

Meanwhile, the linkages 70 are pivotably attached to the eccentric disc 50 in a radial direction, and outer ends thereof support the vertical blades 20 via the link brackets 34 and the link pins 35.

As shown in FIG. 6, when the wind direction is directed in an arrow direction, the wind direction bar 60 maintains a direction as indicated by a chain double-dashed line arrow. The eccentric coupling 40 cooperates with the wind direction bar 60. The rotary shaft 31 is exposed through a rotary shaft hole 45 of the eccentric coupling 40. The vertical blades 20 coupled to the end discs via the fixing bars 30 are pivoted around the hinge pins 32.

The eccentric disc 50 is eccentrically rotated around the rotary shaft 31 by the eccentric stud 43 that is eccentrically directed according to the wind direction as shown in FIG. 6. The wind pressure is applied to the vertical blades 20, and is transmitted to the rotary shaft 31 as wind power. This wind power generates electricity.

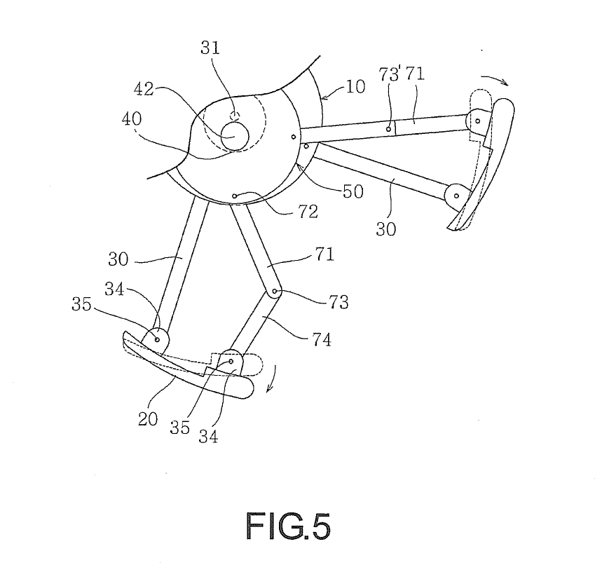

In this case, an eccentric force causes the eccentric coupling 40 to cooperate with the vertical blades 20. As shown in FIG. 5, the hinge pins 32 are located within a constant radius by the fixing bars 30. The linkages 70 are bent by the eccentric disc 50 cooperating with the eccentric coupling 40. Thereby, each vertical blade 20 has a different angle as indicated by a solid line or a dotted line. This angle is increased at a side that is parallel to the wind direction as shown in FIG. 6.

In addition, the linkages 70 are radically disposed in the state in which the first link 71 and the second link 74 are pivotably coupled by the middle link pin 73. One of the linkages 70 is fixed by a fixing screw 73′, and maintains a fixed state in the event of power transmission. The fixed linkage functions as a force transmission bar due to a fixed joint structure using the fixing screw. The eccentric disc 50 and the end discs 10 are operated so that the eccentric force caused by the eccentric bearing 40 and the joint structure of the linkage 70 organically transmit power. Of course, to prevent noise, bearings are coupled to the hinge pins 32 and the link pins 35. Thus, the power can be transmitted without vibration and noise.

Although exemplary embodiments of the present invention have been described for illustrative purposes, those skilled in the art will appreciate that various modifications, additions and substitutions are possible, without departing from the scope and the spirit of the invention as disclosed in the accompanying claims.

What is claimed is:

1. A wind turbine rotor having vertical blades whose angles vary depending on a direction of wind, in which the vertical blades supported on end discs attached to opposite ends of a rotary shaft are rotated by wind energy, the wind turbine rotor comprising:
fixing bars (30) that are radially separated from and fixed to the end discs (10) at a given angle and pivotably attach the vertical blades (20) to ends thereof via hinge pins (32) for adjusting a rotational angle;
an eccentric coupling (40) that is pivotably attached to the upper end of the rotary shaft (31) attached to the end discs (10) via a first bearing (41) and has an eccentric stud (43) protruding from an upper surface thereof;
an annular eccentric disc (50) that is pivotably attached to an outer circumferential surface of the eccentric stud (43) via a second bearing (42);
a wind direction bar (60) that is integrally fixed to an upper portion of the eccentric stud (43); and
linkages (70) that are connected so that a distance between the eccentric disc (50) and each vertical blade (20) is adjusted and function to change a wind direction angle of each vertical blade (20) around each hinge pin (32).

2. The wind turbine rotor according to claim 1, wherein each vertical blade (20) includes the hinge pins (32), each of which is pivotably attached to a hinge bracket (33) on one side of an inner surface thereof, and a link pin (35) attached to a link bracket (34) on the other side of the inner surface thereof at a position spaced apart from the hinge pin (32) in a widthwise direction, and the linkages (70) are pivotably attached to the respective link pins (35).

3. The wind turbine rotor according to claim 2, wherein:
each linkage (70) includes a first link (71), one end of which is pivotably attached to the eccentric disc (50) via a link pin (72) in a radial direction, and a second link (74), one end of which is linked to the other end of the first link (71) via a middle link pin (73);
the other end of the second link (74) is pivotably attached to the link pin (35); and
one of the middle link pins (73) of the first links (71) disposed in a radial direction is fixed as a fixing screw.

4. The wind turbine rotor according to claim 1, wherein each vertical blade (20) includes a step (22) on an inner or outer surface thereof which increases wind pressure.

5. The wind turbine rotor according to claim 2, wherein each vertical blade (20) includes a step (22) on an inner or outer surface thereof which increases wind pressure.

6. The wind turbine rotor according to claim 1, wherein the eccentric disc (50) includes a bearing dam (52) that protrudes from a bottom surface thereof in a ring shape so as to hold the second bearing (42), and an eccentric stud hole (54) that is formed around a central axis thereof so as to prevent a rotating force thereof from being transmitted to the eccentric stud (43) and functions to fix a lower end of a wind direction bar fixing shaft (62) coupled with the wind direction bar (60) to the eccentric stud (43) so that the wind direction bar fixing shaft (62) is located.
